(19) United States
(12) Patent Application Publication
(10) Pub. No.: US 2026/0302083 A1
(43) Pub. Date: Oct. 1, 2026

(54) LAMINATED CERAMIC CAPACITOR AND METHOD OF MANUFACTURING LAMINATED CERAMIC CAPACITOR

(71) Applicant: TAIYO YUDEN CO., LTD., Tokyo (JP)

(72) Inventor: Fumiya HOSHINO, Tokyo (JP)

(21) Appl. No.: 19/573,387

(22) Filed: Mar. 20, 2026

(30) Foreign Application Priority Data
Mar. 26, 2025 (JP) 2025-051193

(51) Int. Cl. H01G 4/30; H01G 4/12

(52) U.S. Cl. CPC H01G 4/30; H01G 4/1227

(57) ABSTRACT

An aspect of the present disclosure provides a laminated ceramic capacitor including a body and two external electrodes (first and second external electrodes) provided on the body. The body has a stacked section and a side margin section. The stacked section includes a first internal electrode layer, a second internal electrode layer, and a dielectric layer. The dielectric layer contains Si and is positioned between the first and second internal electrode layers in a first direction. The side margin section is formed from an Si-added ceramic material. The first external electrode is electrically connected to the first internal electrode layer, and the second external electrode is electrically connected to the second internal electrode layer. In one aspect of the disclosure, a first concentration indicating an Si concentration in the dielectric layer is higher than a second concentration indicating an Si concentration in the side margin section.

### CROSS-REFERENCE TO RELATED APPLICATIONS

This application is based on and claims the benefit of priority from Japanese Patent Application Serial No. 2025-051193 (filed on Mar. 26, 2025), the contents of which are hereby incorporated by reference in their entirety.

### TECHNICAL FIELD

A known laminated ceramic capacitor has a laminate in which a plurality of dielectric layers and a plurality of internal electrode layers are stacked and in which side margin sections made of a ceramic material are attached to the side surfaces of the laminate. In such a laminated ceramic capacitor, the internal electrode layers extend over the entire width-wise length of the laminate, so that the internal electrode layers have a uniform width-wise dimension. The internal electrode layers are all exposed on the side surfaces (the end surfaces in the width direction) of the laminate. The side margin sections are provided on the side surfaces of the laminate to cover the edges of the internal electrode layers. Due to the uniform width-wise dimension of the internal electrode layers, such a laminated ceramic capacitor achieves excellent capacitance acquisition efficiency. In addition, since the side margin sections are fabricated separately from the laminate, the side margin sections have excellent processability. This makes it easy to reduce the thickness of the side margin sections and make the external dimensions of the laminated ceramic capacitor more compact.

A laminated ceramic capacitor including a laminate and side margin sections on the side surfaces of the laminate is disclosed in Japanese Patent Application Publication No. 2017-028013 (“the '013 Publication”). The '013 Publication discloses that the side margin sections are densified by increasing the Si content in the side margin sections. Since Si becomes the liquid phase during firing and promotes the growth and rearrangement of ceramic crystal grains, the side margin sections are densified by increasing the Si content in the side margin sections. In the '013 Publication, the side margin sections are each divided into an inner layer and an outer layer, and the Si content in the outer layer is higher than that in the inner layer. In addition, in the '013 Publication, the laminate sandwiched between the side margin sections contains almost no Si (see FIG. 5).

Densification of the side margin sections can improve the flexural strength of the side margin sections. The densified side margin sections prevent moisture from penetrating into the laminated ceramic capacitor, thereby improving the reliability of the laminated ceramic capacitor.

As described above, the side margin sections can be densified by increasing the Si content in the side margin sections. The densified side margin sections provide benefits such as increased flexural strength and improved reliability. On the other hand, if the Si content ratio in the side margin sections is higher than that in the laminate, sintering of the ceramic material begins earlier in the side margin sections than in the laminate during firing. During firing, since the side margin sections are densified at an early stage, there is a problem that a decomposition gas generated by thermal decomposition of the organic matter (e.g., binder resin) contained in the laminate precursor is not easily released.

To ensure the release of the decomposition gas after the sintering of the side margin sections has advanced, prolonging the firing time is required. However, if the firing time is increased, the metals in the internal electrode layers become oversintered. Oversintering of the metals in the internal electrode layers results in the reduced continuity of the internal electrode layers, thereby disadvantageously causing a decrease in the capacitance. In addition, a longer firing time may also result in excessive growth of ceramic crystal grains in the dielectric layers. Excessive growth of the ceramic crystal grains causes a reduction in the capacitance and reliability of the laminated ceramic capacitor.

### SUMMARY

It is an object of the present disclosure to solve or alleviate at least part of the drawback mentioned above. One of more particular objects of the disclosure is to provide a laminated ceramic capacitor configured to facilitate release of a gas generated during the manufacturing process and a method of manufacturing such a laminated ceramic capacitor.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

The various inventions disclosed herein may be collectively referred to as “the invention”. An aspect of the disclosure provides a laminated ceramic capacitor including a body and two external electrodes (first and second external electrodes) provided on the body. The body has a stacked section and a side margin section. The stacked section includes a first internal electrode layer, a second internal electrode layer, and a dielectric layer. The dielectric layer contains Si and is positioned between the first and second internal electrode layers in a first direction. The side margin section is formed from an Si-added ceramic material. The first external electrode is electrically connected to the first internal electrode layer, and the second external electrode is electrically connected to the second internal electrode layer. In one aspect of the disclosure, a first concentration indicating an Si concentration in the dielectric layer is higher than a second concentration indicating an Si concentration in the side margin section.

### Advantageous Effects

An embodiment of the invention disclosed herein provides a laminated ceramic capacitor configured to facilitate release of a gas generated during the manufacturing process.

### BRIEF DESCRIPTION OF THE DRAWINGS

FIG. 1 is a perspective view schematically showing a laminated ceramic capacitor according to one embodiment of the disclosure.

FIG. 2 is a sectional view schematically showing a section of the laminated ceramic capacitor of FIG. 1 taken along the line I-I.

FIG. 3 is a sectional view schematically showing a section of the laminated ceramic capacitor of FIG. 1 taken along the line II-II.

FIG. 4 is an enlarged sectional view showing a part of the section shown in FIG. 3 on an enlarged scale.

FIG. 5 is a flowchart showing a flow of a method of manufacturing a capacitor according to one embodiment of the disclosure.

FIG. 6A schematically illustrates a step of forming a first internal electrode pattern on a laminate ceramic green sheet, in the method of manufacturing a laminated ceramic capacitor.

FIG. 6B schematically illustrates a step of forming a second internal electrode pattern on a laminate ceramic green sheet, in the method of manufacturing a laminated ceramic capacitor.

FIG. 7 schematically illustrates a step of forming a laminate, in the method of manufacturing a laminated ceramic capacitor.

FIG. 8 is a schematic perspective view of a chip laminate.

FIG. 9 is a schematic perspective view of a chip laminate with side margin sections.

FIG. 10A schematically illustrates a step of attaching a side-margin-section ceramic green sheet onto a chip laminate.

FIG. 10B schematically illustrates the step of attaching a side-margin-section ceramic green sheet onto a chip laminate.

FIG. 11A is an enlarged schematic sectional view of the boundary between the chip laminate and the side-margin-section ceramic green sheet in a ceramic element before firing.

FIG. 11B is a graph showing an Si concentration in the ceramic element measured before firing.

FIG. 12A is an enlarged schematic sectional view of the boundary between a laminate and a first side margin section in a body obtained by firing the ceramic element.

FIG. 12B is a graph showing an Si concentration measured in the body obtained by firing the ceramic element.

### DESCRIPTION OF THE PREFERRED EMBODIMENTS

Various embodiments of the disclosure will be described hereinafter with reference to the appended drawings. Throughout the drawings, the same components are denoted by the same or like reference numerals. It should be noted that the drawings are not necessarily drawn to an accurate scale for the sake of convenience of explanation. The following embodiments of the disclosure do not limit the scope of the claims. The elements included in the following embodiments are not necessarily essential to solve the problem addressed by the invention.

For convenience of explanation, each of the drawings may show the L axis, the W axis, and the Taxis orthogonal to one another. In this specification, the dimensions, arrangement, shape, and other features of each component of a laminated ceramic capacitor 1 may be described with reference to the L, W, and T axes.

### (1) Laminated Ceramic Capacitor 1

### (1-1) Basic Structure of Laminated Ceramic Capacitor 1

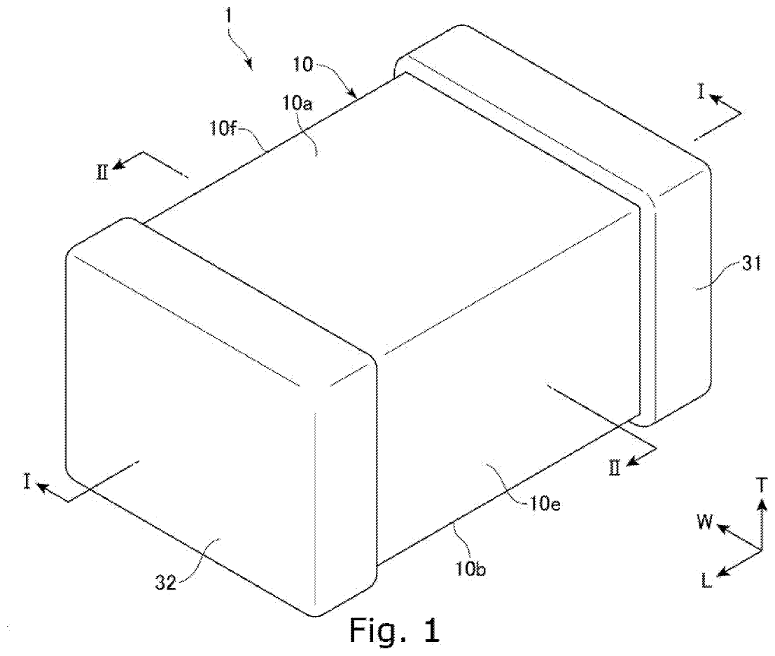

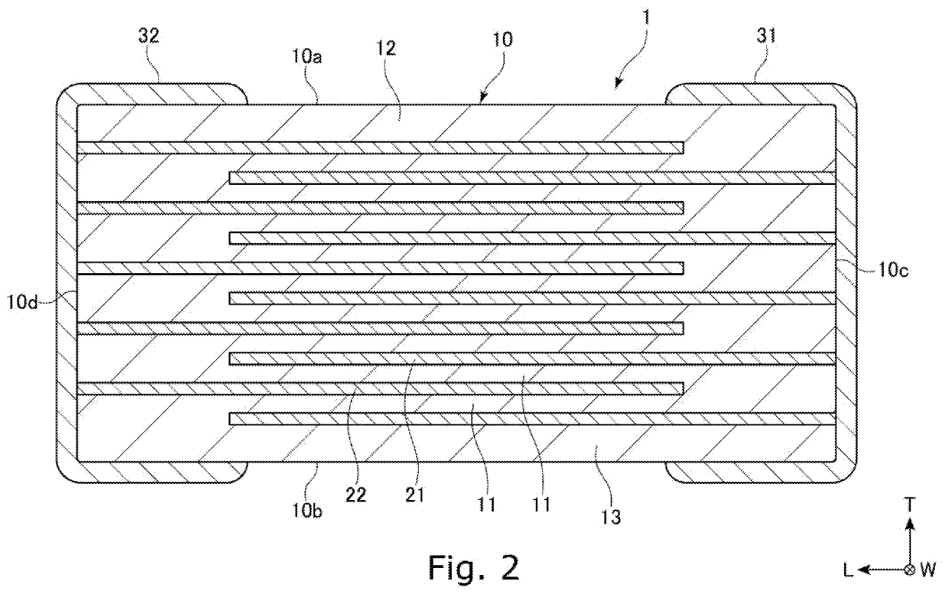

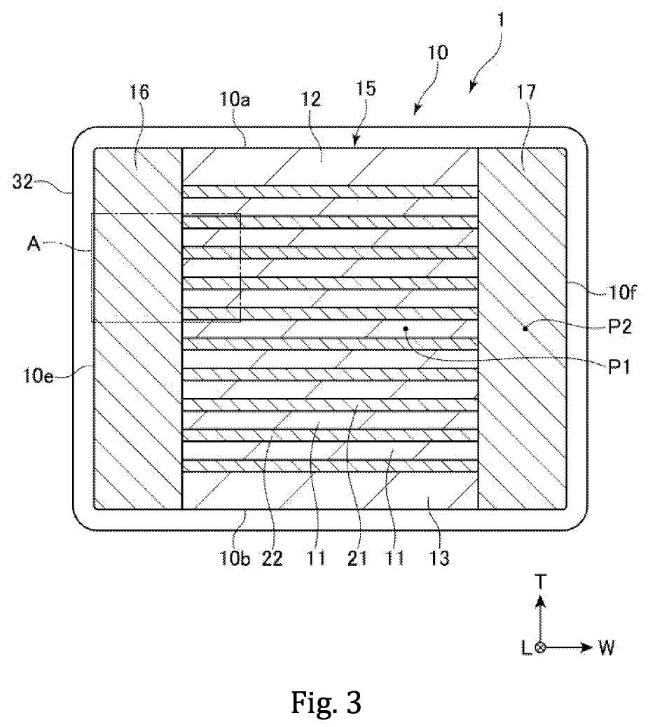

Referring to FIGS. 1 to 3, the basic structure of a laminated ceramic capacitor 1 relating to one embodiment is described. FIG. 1 is a perspective view showing the laminated ceramic capacitor 1 according to the embodiment. FIG. 2 is a sectional view schematically showing a section of the laminated ceramic capacitor 1 taken along the line I-I. FIG. 3 is a sectional view schematically showing a section of the laminated ceramic capacitor 1 taken along the line II-II.

The laminated ceramic capacitor 1 has a body 10, and a first external electrode 31 and a second external electrode 32 provided on the body 10. The first external electrode 31 is spaced apart from the second external electrode 32.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

In one aspect, the laminated ceramic capacitor 1 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the laminated ceramic capacitor 1 may be larger than the width thereof. In one aspect, the width of the laminated ceramic capacitor 1 may be larger than the length thereof.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

### (1-2) Regions of Body 10

The body 10 is divided into a stacked section 15, a first side margin section 16, and a second side margin section 17, as shown in FIG. 3. The stacked section 15 is located between the first side margin section 16 and the second side margin section 17 in the W-axis direction. In other words, the stacked section 15 is sandwiched between the first side margin section 16 and the second side margin section 17. As used herein, when it is not necessary to distinguish between the first side margin section 16 and the second side margin section 17, they are sometimes collectively referred to as the “side margin sections”.

The stacked section 15 includes a plurality of dielectric layers 11, a plurality of first internal electrode layers 21, and a plurality of second internal electrode layers 22. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other. In the stacked section 15, the dielectric layers 11 are positioned between adjacent ones of the internal electrode layers. In the stacked section 15, a first internal electrode layer 21 is provided on the top surface of a dielectric layer 11, and a second internal electrode layer 22 is provided on the bottom surface of the dielectric layer 11.

In the stacked section 15, the dielectric layers 11, the first internal electrode layers 21, and the second internal electrode layers 22 are stacked along a lamination direction. In the illustrated embodiment, the dielectric layers 11, the first internal electrode layers 21, and the second internal electrode layers 22 are stacked together along the T-axis direction.

The dielectric layers 11 located at the opposite ends in the lamination direction may be referred to as cover layers. In the example shown in FIG. 2, an upper cover layer 12 is provided at the top end in the lamination direction, and a lower cover layer 13 is provided at the bottom end in the lamination direction. The upper cover layer 12 and the lower cover layer 13 may be formed of the same material as the dielectric layers 11. The upper and lower cover layers 12 and 13 may be part of the stacked section 15.

Each of the first internal electrode layers 21 has one end led toward the outside of the body 10. The first internal electrode layer 21 is led toward the outside of the body 10 through the first end surface 10c and connected to the first external electrode 31 provided on the surface of the body 10. Each of the second internal electrode layers 22 has one end led toward the outside of the body 10 through the second end surface 10d and connected to the second external electrode 32 provided on the surface of the body 10. As shown in FIG. 3, both the first internal electrode layers 21 and the second internal electrode layers 22 extend over the entire width of the stacked section 15 in the W-axis direction. Therefore, the opposite ends of each first internal electrode layer 21 in the W-axis direction are both exposed on the side surfaces of the stacked section 15. Similarly, the opposite ends of each second internal electrode layer 21 in the W-axis direction are both exposed on the side surfaces of the stacked section 15. The end surfaces of the first and second internal electrode layers 21 and 22, which are exposed on the side surfaces of the stacked section 15, are covered by the first and second side margin sections 16 and 17.

The side margin sections are the regions of the body 10 where neither the first internal electrode layers 21 nor the second internal electrode layers 22 are present as viewed from the lamination direction. As shown in FIG. 3, neither the first internal electrode layers 21 nor the second internal electrode layers 22 are present in the first side margin section 16. Similarly, neither the first internal electrode layers 21 nor the second internal electrode layers 22 are present in the second side margin section 17.

### (1-3) Dielectric Layers 11

The dielectric layers 11 are formed of a ceramic material. The dielectric layers 11 contain a plurality of crystal grains (ceramic crystal grains) constituting a sintered body of the ceramic material. At least some of the ceramic crystal grains have a core-shell structure. The ceramic crystal grains having a core-shell structure each have a core section and a shell section surrounding the core section.

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 contain Si in addition to the oxide or the main component. The dielectric layers 11 contain Si at a first concentration. Si is added as a sintering agent to the raw material for the dielectric layers 11. In the firing step during the manufacturing process of the laminated ceramic capacitor 1, Si acts as a sintering agent by forming a liquid-phase glass containing SiO₂, which wets and spreads over the surface of the ceramic material. The use of SiO₂ as a sintering agent enables sintering at lower temperatures in the manufacturing process of the laminated ceramic capacitor 1, which can save the energy required for the manufacturing process.

In addition to the main component oxide and Si, the dielectric layers 11 can contain elements derived from known sintering agents. Examples of the known sintering agents are Mg (magnesium) and Mn (manganese).

The dielectric layers 11 can contain additive elements other than those listed above. In one aspect, the additive elements contained in the dielectric layers 11 are at least one element selected from the group consisting of Ni (nickel), Mo (molybdenum), Nb (niobium), Ta (tantalum), W (tungsten), V (vanadium), and Cr (chromium). The dielectric layers 11 may contain two or more of the above additive elements.

The dielectric layers 11 may contain oxides of rare earth elements. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of Co (cobalt), Li (lithium), B (boron), Na (sodium), and K (potassium), for example. The dielectric layers 11 may contain oxides of two or more of these elements.

The dielectric layers 11 may contain glass containing at least one element selected from the group consisting of Co, Ni, Li, B, Na, and K.

In one aspect, the thickness (the dimension in the T-axis direction) of each dielectric layer 11 is 0.2 μm to 0.8 μm.

### (1-4) First Internal Electrode Layers 21 and Second Internal Electrode Layers 22

In one aspect, the first internal electrode layers 21 contain a base metal such as Ni (nickel), Cu (copper), and Sn (tin), as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more a base metal as the main component thereof.

The first internal electrode layers 21 can contain additive metal elements in addition to the main component metal element. The additive metal elements that can be contained in the first internal electrode layers 21 are, for example, metals that are more noble than the main component metal of the first internal electrode layers 21.

The additive metal elements that can be contained in the first internal electrode layers 21 are one or more elements selected from the group consisting of, for example, Au, Sn, Cr, Y, In (indium), As (arsenic), Co, Cu, Ir (iridium), Mg, Os (osmium), Pd, Pt, Re (rhenium), Rh (rhodium), Ru (ruthenium), Se (selenium), Te (tellurium), W and Zn (zinc).

The description of the components of the first internal electrode layers 21 also applies to the components of the second internal electrode layers 22.

In an aspect, the thickness (the dimension in the T-axis direction) of each first internal electrode layer 21 and the thickness (the dimension in the T-axis direction) of each second internal electrode layer 22 are both 0.1 μm to 0.6 μm.

FIGS. 2 and 3 show five first internal electrode layers 21 and five second internal electrode layers 22 for simplicity of illustration, but there may be six or more first internal electrode layers 21 and six or more second internal electrode layers 22. For example, the laminated ceramic capacitor 1 may include 300 to 1000 layers of the first and second internal electrode layers 21 and 22.

### (1-5) Side Margin Sections

The side margin sections include the first side margin section 16 and the second side margin section 17. The first side margin section 16 and the second side margin section 17 are formed of a Si-added ceramic material. The first and second side margin sections 16 and 17 contain a plurality of crystal grains (ceramic crystal grains) constituting a sintered body of the ceramic material. The main component of the first and second side margin sections 16 and 17 may be the same as the main component of the dielectric layers 11. For example, when the main component of the dielectric layers 11 is barium titanate, the main component of the first and second side margin sections 16 and 17 can also be barium titanate. The first and second side margin sections 16 and 17 can contain the same type of additive elements as those added to the dielectric layers 11.

Although the manufacturing method will be described in detail below, the first and second side margin sections 16 and 17 are structures that are formed separately from the stacked section 15. The body 10 is fabricated by forming and firing a ceramic element. The ceramic element is formed as follows. The precursors of the first and second side margin sections 16 and 17 are separately formed from the precursor of the stacked section 15, and the precursors of the first and second side margin sections 16 and 17 are attached to the precursor of the stacked section 15. This manufacturing method can contribute to reducing the dimensions of the first and second side margin sections 16 and 17 in the W-axis direction. The dimensions of the first and second side margin sections 16 and 17 in the W-axis direction can be, for example, equal to or less than 30 μm, preferably equal to or less than 15 μm. Assuming that the body 10 has a fixed dimension in the W-axis direction, a reduction in the dimension in the W-axis direction of the side margin sections lead to an increase in the dimension of the stacked section, thereby increasing the capacitance of the laminated ceramic capacitor 1.

As described above, the dielectric layers 11 contain Si at the first concentration. The first and second side margin sections 16 and 17 contain Si at a second concentration lower than the first concentration. To distinguish from the first concentration, which indicates the Si concentration in the dielectric layers 11, the Si concentration in the first side margin section 16 and the Si concentration in the second side margin section 17 are both referred to as the “second concentration,” but the Si concentration in the first side margin section 16 may be different from the Si concentration in the second side margin section 17. As the difference between the first and second concentrations increases, the difference between the growth of the ceramic crystal grains in the dielectric layers 11 and the growth of the ceramic crystal grains in the first and second side margin sections 16 and 17 increases. In one embodiment, the first concentration is two or more times higher than the second concentration. In one embodiment, the first concentration is three or more times higher than the second concentration. In one embodiment, the first concentration is five or more times higher than the second concentration. As the first concentration increases, the electrical properties of the main component oxide of the dielectric layers 11 (e.g., barium titanate) are more significantly affected, which may lead to a reduction in the dielectric constant. Therefore, the ratio of the first concentration to the second concentration is preferably capped. In one embodiment, the first concentration is no more than 10 times higher than the second concentration.

Because the Si concentration in the stacked section 15 is higher than that in the first and second side margin sections 16 and 17, the ceramic crystal grains in the stacked section 15 grow at a lower temperature (i.e., at an earlier time) than the ceramic crystal grains in the first and second side margin sections 16 and 17 during firing. During firing, the precursor of the stacked section 15 generates a gas due to the organic matter contained in the raw material. This gas is pushed out of the precursor of the stacked section 15 as the ceramic crystal grains grow in the precursor of the stacked section 15. The ceramic crystal grains in the precursors of the first and second side margin sections 16 and 17 grow more slowly than the ceramic crystal grains in the precursor of the stacked section 15. At the time the ceramic crystal grains begin to grow in the precursor of the stacked section 15 and the gas is pushed out, the ceramic crystal grains are not yet densely arranged in the precursors of the first and second side margin 16 and 17. Therefore, at the time the gas is pushed out of the precursor of the stacked section 15, the precursors of the first and second side margin sections 16 and 17 still have voids through which the gas expelled from the stacked section 15 can pass. In other words, the gas generated in the precursor of the stacked section 15 during firing passes through the voids in the precursors of the first and second side margin sections 16 and 17 to be released to the outside. Thus, the laminated ceramic capacitor 1 is configured to facilitate the outward release of the gas that is generated in the precursor of the stacked section 15 during firing, compared to conventional laminated ceramic capacitors in which the Si concentration in the side margin sections (the second concentration) is higher than the Si concentration in the stacked section (the first concentration).

The concentrations of the elements in the body 10 are measured by, for example, TEM-EDX, STEM-EDS, Electron Probe Micro Analyzer (EPMA) or other known measurement methods. The first and second concentrations of Si can also be measured by these known methods. The concentrations of the elements in the body 10 can be measured using any known method capable of quantifying the concentrations of the elements in the dielectric and internal electrode layers.

### (1-6) Structure Near Boundaries Between Stacked Section 15 and Side Margin Sections

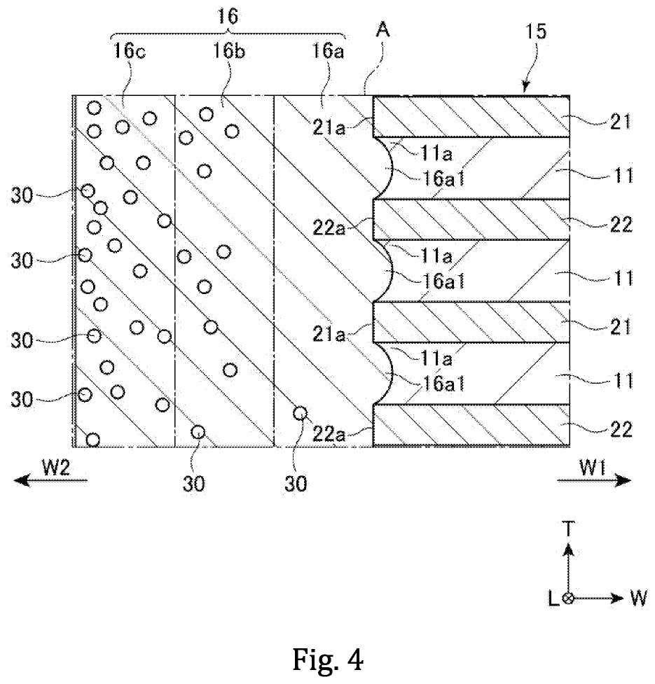

With further reference to FIG. 4, the structure near the boundaries between the stacked section 15 and the side margin sections is described. FIG. 4 is an enlarged sectional view schematically showing part of the section of the body 10 shown in FIG. 3 and taken along the WT plane, which is near the boundary between the stacked section 15 and the first side margin section 16. The structure near the boundary between the stacked section 15 and the second side margin section 17 may be the same as the structure near the boundary between the stacked section 15 and the first side margin section 16. The following description of the structure near the boundary between the stacked section 15 and the first side margin section 16 also applies to the structure near the boundary between the stacked section 15 and the second side margin section 17. Therefore, the structure near the boundary between the stacked section 15 and the second side margin section 17 are neither illustrated or described in detail.

The first side margin section 16 is divided into three equal portions arranged next to each other in the W-axis direction. Of these three equal portions, the region nearest the stacked section 15 and in contact with the stacked section 15 is referred to as an inner portion 16a, the region most distant from the stacked section 15 is referred to as an outer portion 16c, and the region sandwiched between the inner portion 16a and the outer portion 16c in the W-axis direction is referred to as a middle portion 16b. The middle portion 16b is in contact with both the inner portion 16a and the outer portion 16c. The dimensions of the inner portion 16a, the middle portion 16b, and outer portion 16c in the W-axis direction are equal to each other.

As illustrated, each dielectric layer 11 has a recess 11a that is recessed toward the inside of the stacked section 15 (the W1 direction). The recess 11a is recessed toward the inside of the stacked section 15 with respect to the line connecting an end face 21a of the first internal electrode layer 21 facing the W2 direction and an end face 22a of the second internal electrode layer 22 facing the W2 direction, as shown in the section in FIG. 4.

The first side margin section 16 has a plurality of protrusions 16a1 protruding toward the inside of the stacked section 15 in the portions that are in contact with the dielectric layers 11. Each of the protrusions 16a1 has a complementary shape to the corresponding one of the recesses 11a. In other words, the first side margin section 16 is provided next to the stacked section 15 such that the protrusions 16a1 are embedded into the dielectric layers 11. As the boundary is configured in this manner, the adhesion of the first side margin section 16 to the stacked section 15 can be improved. The improved adhesion of the first side margin section 16 to the stacked section 15 prevents the first side margin section 16 from peeling off the stacked section 15.

### (1-7) Voids 30 in Side Margin Sections

The first side margin section 16 is densified to prevent water vapor and other foreign matter from entering the laminated ceramic capacitor 1. By including Si, which acts as a sintering agent, in the raw material for the first side margin section 16, the first side margin section 16 can be densified. Of the first side margin section 16, the inner portion 16a is the densest. The dense inner portion 16a can prevent the entry of foreign matter. As shown in FIG. 4, when observing the cut surface of the first side margin portion 16 taken along the WT plane, a first area, which indicates the area occupied by the voids 30 in the inner portion 16a, is equal to or less than 0.5% of the area of the inner portion 16a (inner portion area). The inner portion 16a need not contain any voids 30 at all.

In one embodiment, the first side margin section 16 is configured such that the voids increase toward the outside of the laminated ceramic capacitor 1 (the W2 direction). Specifically, a second area, which represents the area occupied by the voids 30 in the middle portion 16b, is greater than the first area, which represents the area occupied by the voids 30 in the inner portion 16a. A third area, which indicates the area occupied by the voids 30 in the outer portion 16c, is greater than the second area, which indicates the area occupied by the voids 30 in the middle portion 16b.

The area occupied by the voids 30 in the first side margin section 16 can be determined as follows. First, the body 10 is cut along the WT plane to expose a section. The section, to be specific, a region within the first side margin section 16 is photographed by a scanning electron microscope (SEM) at a predetermined magnification (e.g., 10000 times). As a result, an SEM image with a portion of the section of the first side margin section 16 as the field of view is obtained. The captured SEM image is then subjected to image processing such as binarization, so that voids and non-void regions are distinguished from each other and the area of the regions classified as the voids is calculated. The binarization may be replaced with multi-value processing. The total area of the voids in the inner portion 16a in the field of view can be defined as the first area. Similarly, the total area of the voids in the middle portion 16b in the field of view can be defined as the second area, and the total area of the voids in the outer portion 16c in the field of view can be defined as the third area.

As mentioned above, the first side margin section 16 contains Si at the second concentration lower than the first concentration, which represents the Si concentration in the dielectric layers 11. For this reason, the first side margin section 16 is less likely to be densified during firing than the dielectric layers 11, and thus contains the voids 30. The inner portion 16a of the first side margin section 16 is in contact with the dielectric layers 11, which contain Si abundantly. During firing, Si is transformed into liquid-phase glass containing SiO₂ and is likely to flow from the precursors of the dielectric layers 11 into the precursor of the inner portion 16a. In the precursor of the inner portion 16a, the growth and rearrangement of the ceramic crystal grains are promoted due to the supply of Si from the precursors of the dielectric layers 11 during firing. For the reasons stated above, the inner portion 16a is more easily densified than the middle portion 16b and outer portion 16c as it is in contact with the Si-rich dielectric layers 11. Therefore, the first area occupied by the voids 30 in the inner portion 16a is smaller than the second area occupied by the voids 30 in the middle portion 16b and the third area occupied by the voids 30 in the outer portion 16c.

Because Si migrates from the precursors of the dielectric layers 11 to the precursor of the first side margin section 16 during firing, the Si concentration in the inner portion 16a of the first side margin section 16, which is the nearest the dielectric layers 11, is higher than those in the middle and outer portions 16b and 16c. Similarly, the Si concentration in the middle portion 16b is higher than that in the outer portion 16c. Taking into account the non-uniform Si concentration in the first side margin section 16, the Si concentration measured at the middle in the W-axis direction of the first side margin section 16 can be used as the second concentration indicating the Si concentration in the first side margin section 16. Similarly, the Si concentration measured at the middle in the W-axis direction of the dielectric layers 11 can be used as the first concentration indicating the Si concentration in the dielectric layers 11.

Since the inner portion 16a is densified, the first side margin section 16 can prevent or inhibit foreign matter such as water vapor from entering the stacked section 15 from the outside. Therefore, the laminated ceramic capacitor 1 can ensure a certain level of reliability.

### (1-8) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag (silver), Pd (palladium), Au (gold), Pt (platinum), Ni (nickel), Sn (tin), Cu (copper), W (tungsten), Ti (titanium), and alloys of these.

### (2) Method of Manufacturing Laminated Ceramic Capacitor 1

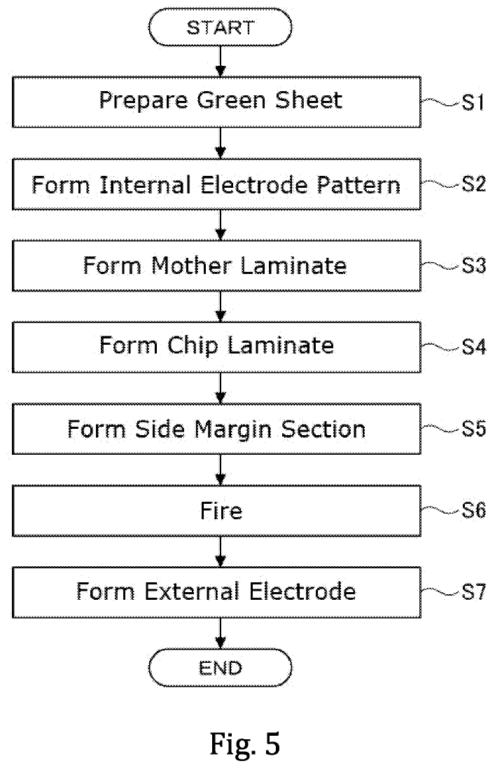

A description will now be given of one example of the method of manufacturing the laminated ceramic capacitor 1 with reference to FIG. 5. FIG. 5 is a flowchart showing a flow of the method of manufacturing the laminated ceramic capacitor 1 according to one embodiment of the disclosure.

In the first step S1, a laminate ceramic green sheet is prepared to form the stacked section 15. Specifically, ceramic powder is first wet-mixed with a binder resin, an organic solvent such as ethanol or toluene, and a plasticizer, to obtain a laminate ceramic slurry. The laminate ceramic slurry is coated on a substrate film using, for example, the die coater or doctor blade method, and then the laminate ceramic slurry coated on the substrate film is dried, to obtain a laminate ceramic green sheet.

The ceramic powder used as the raw powder of the laminate ceramic green sheet is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

By mixing silicon resin into the raw powder for the laminate ceramic green sheet, a more flexible laminate ceramic green sheet can be obtained. Silicon resin is added at a ratio of, for example, 2 to 5 wt % to 100 wt % of the main component oxide.

Si is added to the raw powder for the laminate ceramic green sheet. For example, Si oxide powder or silicon resin is mixed with the raw powder for the laminate ceramic green sheet. In the laminate ceramic slurry, Si is added at a ratio of, for example, 3 to 6 at % to 100 at % of the main component oxide.

The binder resin in the laminate ceramic slurry is, for example, polyvinyl butyral (PVB) resin. To obtain the laminate ceramic slurry, the binder resin is added at a ratio of, for example, 9 to 12 wt % to 100 wt % of the main component oxide.

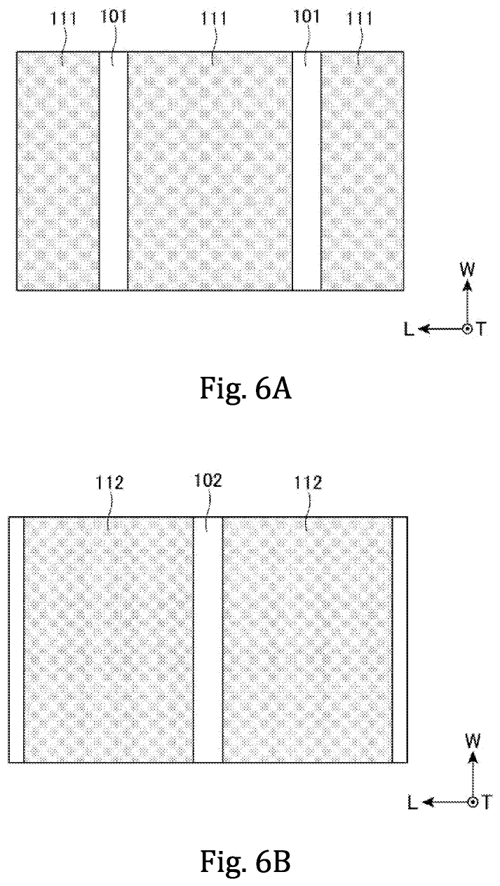

In the next step S2, internal electrode patterns are formed on a plurality of laminate ceramic green sheets, which are made in the above-described manner. Specifically, as shown in FIG. 6A, a plurality of first internal electrode patterns 111 are formed next to each other in the L-axis direction at predetermined intervals on a first laminate ceramic green sheet 101, which is part of the laminate ceramic green sheets prepared in the step S1. Each of the first internal electrode patterns 111 is provided on the first laminate ceramic green sheet 101 and extends in the W-axis direction over the entire width. As shown in FIG. 6B, a plurality of second internal electrode patterns 112 are formed next to each other in the L-axis direction at predetermined intervals on a second laminate ceramic green sheet 102, which is part of the laminate ceramic green sheets prepared in the step S1. Each of the second internal electrode patterns 112 is provided on the second laminate ceramic green sheet 102 and extends in the W-axis direction over the entire width.

The first and second internal electrode patterns 111 and 112 are formed, for example, by printing a paste for the internal electrodes on the laminate ceramic green sheets by screen printing or other known printing methods. The paste for the internal electrodes may be produced by kneading and mixing a metal powder, a binder resin, and a solvent by a three-roll mill. The paste for the internal electrodes produced as described above has the metal powder dispersed in the binder resin. The organic binder used in the paste for the internal electrodes may be a cellulose-based resin such as ethyl cellulose or an acrylic resin such as butyl methacrylate. The first and second internal electrode patterns 111 and 112 may be formed by any method other than printing, for example, thin-film processes such as sputtering or vapor deposition.

In the following step S3, a mother laminate is formed. Specifically, as shown in FIG. 7, the first laminate ceramic green sheets 101 and the second laminate ceramic green sheets 102 prepared in the step S2 are alternately stacked in the T-axis direction, thereby forming a mother laminate. The top layer of the mother laminate may be formed by stacking a plurality of laminate ceramic green sheets 103 that have no internal electrode patterns formed. The bottom layer of the mother laminate may be formed by stacking a plurality of laminate ceramic green sheets 104 that have no internal electrode patterns formed. In the mother laminate, the first internal electrode patterns 111 face the second internal electrode patterns 112 in the T-axis direction.

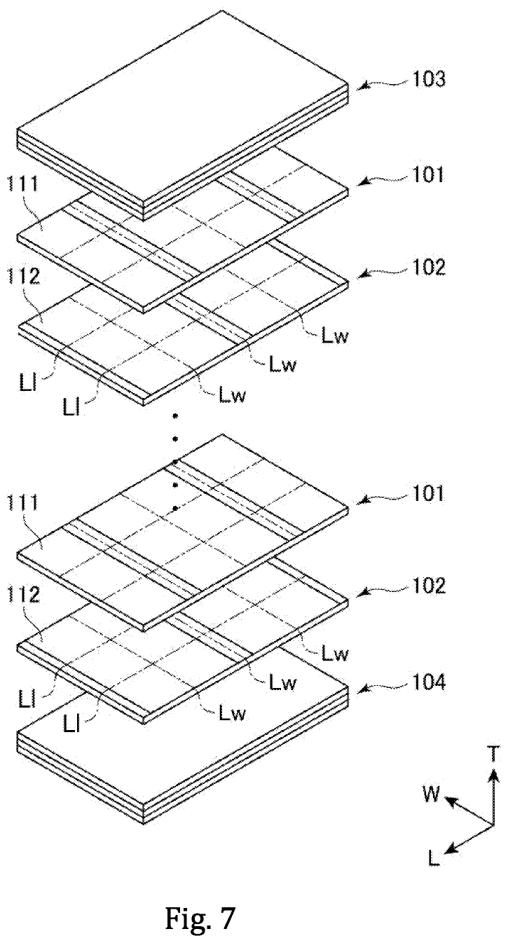

In the next step S4, the mother laminate is cut into chip laminates 120, one of which is shown in FIG. 8. Specifically, the mother laminate is cut in the lamination direction (T-axis direction) along first cutting lines Ll and second cutting lines Lw shown in FIG. 7, so that the chip laminate 120 shown in FIG. 8 is obtained. The first cutting lines Ll extend along the L-axis direction, and the second cutting lines Lw extend along the W-axis direction. The mother laminate may be cut by, for example, a push-cut blade or a rotary blade.

The chip laminate 120 has a top surface 120a, a bottom surface 120b, a first end surface 120c, a second end surface 120d, a first side surface 120e, and a second side surface 120f. The first and second end surfaces 120c and 120d are cut surfaces that are exposed by cutting the mother laminate along the second cutting lines Lw. The first and second side surfaces 120e and 120f are cut surfaces that are exposed by cutting the mother laminate along the first cutting lines Ll. As shown in FIG. 8, the end surfaces of the first and second internal electrode patterns 111 and 112 are both exposed on the first side surface 120e. Although not visible in FIG. 8, the end surfaces of the first and second internal electrode patterns 111 and 112 are also exposed on the second side surface 120f, similarly to the first side surface 120e.

The chip laminate 120 is the precursor of the stacked section 15. The first and second laminate ceramic green sheets 101 and 102 included in the chip laminate 120 are the precursors of the dielectric layers 11, the first internal electrode patterns 111 are the precursors of the first internal electrode layers 21, and the second internal electrode patterns 112 are the precursors of the second internal electrode layers 22.

Next, in the step S5, ceramic green sheets for the side margin sections are prepared, and these side-margin-section ceramic green sheets are attached to the first and second side surfaces 120e and 120f of the chip laminate 120.

The side-margin-section ceramic green sheets are formed by coating a side-margin-section ceramic slurry onto a substrate film and drying the side-margin-section ceramic slurry coated on the substrate film.

The side-margin-section ceramic slurry is obtained by wet mixing ceramic powder with a binder such as polyvinyl butyral (PVB) resin, an organic solvent such as ethanol or toluene, and a plasticizer.

Here, Si is added to the raw powder for the side-margin-section ceramic green sheets. For example, Si oxide powder is mixed with the raw powder for the side-margin-section ceramic green sheets. To prepare the side-margin-section ceramic slurry, the amount of Si added is determined such that the Si concentration in the side-margin-section ceramic slurry is lower than that in the laminate ceramic slurry. When preparing the side-margin-section ceramic slurry, Si is added at a ratio of, for example, 0.5 to 2 at % to 100 at % of the main component oxide.

The binder resin in the side-margin-section ceramic slurry is, for example, polyvinyl butyral (PVB) resin. The amount of the binder resin added in the side-margin-section ceramic slurry is determined such that the content ratio of the binder resin in the side-margin-section ceramic slurry is lower than that in the laminate ceramic slurry. Since the content ratio of the binder resin in the side-margin-section ceramic slurry is controlled to be lower than that in the laminate ceramic slurry, the side-margin-section ceramic green sheets can achieve higher rigidity than the laminate ceramic green sheets. When preparing the side-margin-section ceramic slurry, the binder resin is added at a ratio of, for example, 5 to 7 wt % to 100 wt % of the main component oxide.

In one embodiment, the side-margin-section ceramic slurry does not contain silicon resin. The side-margin-section ceramic slurry may contain silicon resin at a lower content ratio than the laminate ceramic slurry. The side-margin-section ceramic green sheets preferably have higher rigidity than the laminate ceramic green sheets, for the reasons described below. As described above, by not including silicon resin in the side-margin-section ceramic slurry or by controlling the silicon resin content ratio in the side-margin-section ceramic slurry to be lower than that in the laminate ceramic slurry, the side-margin-section ceramic green sheets can achieve higher rigidity than the laminate ceramic green sheets. Silicon resin does not decompose until high temperatures are reached during firing. For this reason, a high content of silicon resin in the side-margin-section ceramic green sheets may inadvertently lead to closure of the voids by silicon resin, through which a gas can be released. Therefore, it is preferable that the side-margin-section ceramic green sheets contain no silicon resin.

The side-margin-section ceramic green sheets are attached to the first and second side surfaces 120e and 120f of the chip laminate 120. For example, the first side surface 120e of the chip laminate 120 is pressed against the side-margin-section ceramic green sheet, so that the chip laminate 120 perforates the side-margin-section ceramic green sheet. In this way, the side-margin-section ceramic green sheet can be attached to the first side surface 120e of the chip laminate 120. Similarly, the second side surface 120f of the chip laminate 120 is pressed against the side-margin-section ceramic green sheet, so that the chip laminate 120 perforates the side-margin-section ceramic green sheet. In this way, the side-margin-section ceramic green sheet can be attached to the second side surface 120f of the chip laminate 120. Attaching the side-margin-section ceramic green sheets to the first and second side surfaces 120e and 120f of the chip laminate 120 can produce a ceramic element 130, which is shown in FIG. 9. The ceramic element 130 is the precursor of the body 10.

The ceramic element 130 has the chip laminate 120, the side-margin-section ceramic green sheet 136 attached to the first side surface 120e of the chip laminate 120, and the side-margin-section ceramic green sheet 137 attached to the second side surface 120f of the chip laminate 120. The side-margin-section ceramic green sheet 136 is provided on the first side surface 120e of the chip laminate 120 to cover the end surfaces of the first and second internal electrode patterns 111 and 112 that are exposed on the first side surface 120e to the outside of the chip laminate 120. The side-margin-section ceramic green sheet 137 is provided on the second side surface 120f of the chip laminate 120 to cover the end surfaces of the first and second internal electrode patterns 111 and 112 that are exposed on the second side surface 120f to the outside of the chip laminate 120.

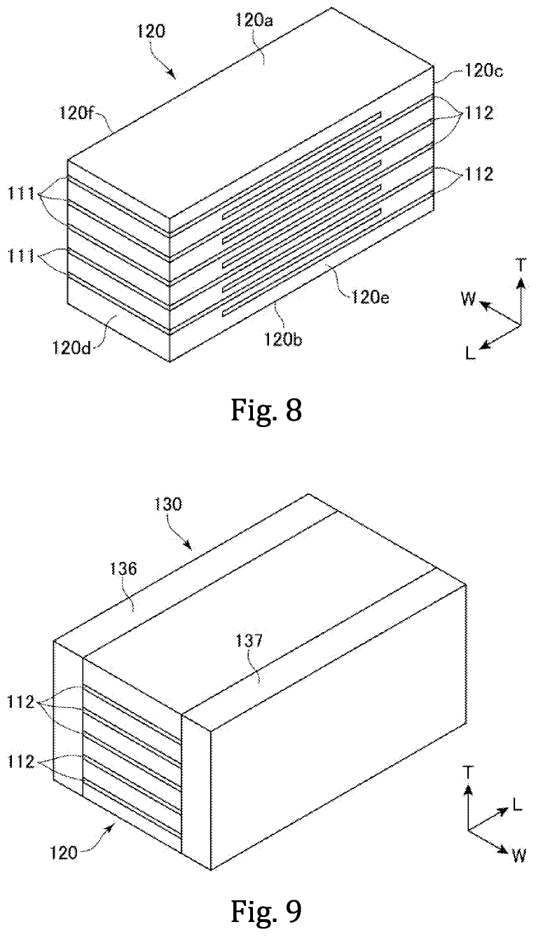

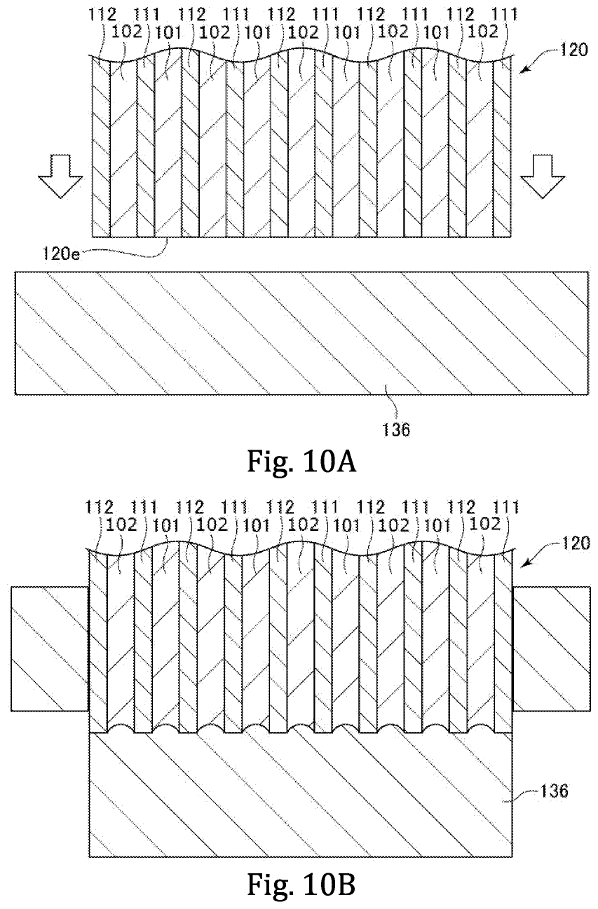

As described above, the side-margin-section ceramic green sheet 136 is attached to the first side surface 120e of the chip laminate 120 by pressing the first side surface 120e of the chip laminate 120 against the side-margin-section ceramic green sheet 136. The first and second laminate ceramic green sheets 101 and 102 in the chip laminate 120 contain higher percentages of the binder resin and silicon resin than the side-margin-section ceramic green sheet 136. Therefore, the first and second laminate ceramic green sheets 101 and 102 are more flexible than the side-margin-section ceramic green sheet 136. According to the method of manufacturing the conventional laminated ceramic capacitor, the portion corresponding to the side-margin-section ceramic green sheet 136 is more flexible than the portions corresponding to the first and second laminate ceramic green sheets 101 and 102. This is because it is desired that the portion corresponding to the side-margin-section ceramic green sheet 136 can adhere to the portion corresponding to the chip laminate 120. In contrast, in the manufacturing method according to one embodiment of the present disclosure, the first and second laminate ceramic green sheets 101 and 102 are configured to have higher flexibility than the side-margin-section ceramic green sheet 136. Therefore, as shown in FIGS. 10A and 10B, when the chip laminate 120 perforates the side-margin-section ceramic green sheet 136, the side-margin-section ceramic green sheet 136 pushes the end surfaces of the first and second laminate ceramic green sheets 101 and 102, which are exposed on the first side surface 120e of the chip laminate 120, toward the inside of the chip laminate 120. Similarly, when the chip laminate 120 perforates the side-margin-section ceramic green sheet 137, the side-margin-section ceramic green sheet 137 pushes the end surfaces of the first and second laminate ceramic green sheets 101 and 102, which are exposed on the second side surface 120f of the chip laminate 120, toward the inside of the chip laminate 120. Accordingly, the side-margin-section ceramic green sheets 136 and 137 are respectively embedded into the first and second side surfaces 120e and 120f of the chip laminate 120, which improves the adhesion between the side-margin-section ceramic green sheets 136 and 137 and the chip laminate 120. When the chip laminate 120 perforates the side-margin-section ceramic green sheet 136, the end surfaces of the first and second internal electrode patterns 111 and 112 are also pressed by the side-margin-section ceramic green sheet 136. The first and second internal electrode patterns 111 and 112 have higher rigidity than the side-margin-section ceramic green sheet 136 because they contain a high density of the main component metal of the internal electrodes. Therefore, when the chip laminate 120 perforates the side-margin-section ceramic green sheet 136, the end surfaces of the first and second internal electrode patterns 111 and 112 are hardly deformed.

In the next step S6, the ceramic element 130 obtained in the step S5 is fired into the body 10 of the laminated ceramic capacitor 1. Specifically, the ceramic element 130 is placed and fired in a firing furnace. The temperature in the firing furnace is raised according to a predetermined temperature profile. For example, the temperature in the firing furnace is raised from room temperature to an intermediate temperature at a rate of 200 to 300° C./h. The intermediate temperature is set slightly lower than the sintering temperature of the main component metal element. When the main component metal element is Ni, the intermediate temperature is set at about 500 to 700° C. An example of the intermediate temperature is 600° C. The temperature in the firing furnace is then increased from the intermediate temperature to a top firing temperature at a rate of 1000 to 3000° C./h. The top firing temperature is, for example, 1000 to 1300° C. An example of the top firing temperature is 1150° C. The holding time at the top firing temperature is set such that the internal electrode layers are prevented from being excessively sintered.

Through the firing process, the chip laminate 120 of the ceramic element 130 becomes the stacked section 15, and the side-margin-section ceramic green sheets 136 and 137 become the first and second side margin sections 16 and 17, respectively. More specifically, the first and second laminate ceramic green sheets 101 and 102 of the chip laminate 120 are fired into the dielectric layers 11, and the first and second internal electrode patterns 111 and 112 are fired into the first and second internal electrode layers 21 and 22, respectively.

During the firing, the SiO₂ powder contained in the first and second laminate ceramic green sheets 101 and 102 and the side-margin-section ceramic green sheets 136 and 137 become liquid-phase glass, which wets and spreads over the surface of the ceramic powder in the respective ceramic green sheets. This facilitates sintering of the ceramic powder. The elements contained in the ceramic powder (for example, Ba and Ti when the ceramic powder is barium titanate powder) dissolve into the liquid-phase component, and the elements dissolved into the liquid-phase component re-precipitate on the surfaces of the crystals, whereby growth of the ceramic crystal grains proceeds. In the liquid-phase component, rearrangement of the ceramic crystal grains proceeds. This leads to densification of the dielectric layers 11 and the first and second side margin sections 16 and 17.

During the firing process, when the temperature in the firing furnace exceeds the thermal decomposition temperature of the resin contained in the respective ceramic green sheets, the resin begins to thermally decompose. The thermal decomposition of the resin generates a decomposition gas. The decomposition gas remains for a while in the ceramic element 130. As the sintering of the ceramic material progresses, the decomposition gas is pushed out by the growing ceramic crystal grains and released to the outside of the ceramic element 130. Since the Si concentration in the first and second laminate ceramic green sheets 101 and 102 of the chip laminate 120 is higher than the Si concentration in the side-margin-section ceramic green sheets 136 and 137, the sintering of the ceramic material in the chip laminate 120 starts at an earlier time (at a lower temperature) than the sintering of the ceramic material in the side-margin-section ceramic green sheets 136 and 137. Therefore, while the ceramic crystal grains grow in the chip laminate 120 and the decomposition gas is released from the chip laminate 120, the growth of the ceramic crystal grains has not progressed in the side-margin-section ceramic green sheets 136 and 137. For this reason, when the decomposition gas is released from the chip laminate 120, the side-margin-section ceramic green sheets 136 and 137 still have release channels that allows the decomposition gas to be released to the outside of the ceramic element 130. In the above-described manner, the release of the decomposition gas from the chip laminate 120 can be facilitated by setting the Si concentration in the first and second laminate ceramic green sheets 101 and 102 of the chip laminate 120 at a higher level than the Si concentration in the side-margin-section ceramic green sheets 136 and 137.

Since the resin content ratio in the side-margin-section ceramic green sheets 136 and 137 is lower than the resin content ratio in the first and second laminate ceramic green sheets 101 and 102, the resin in the side-margin-section ceramic green sheets 136 and 137 is released at an early stage after firing starts. Therefore, the side-margin-section ceramic green sheets 136 and 137 tend to have voids. The decomposition gas, which is produced by the decomposition of the resin contained in the first and second laminate ceramic green sheets 101 and 102, is released to the outside of the ceramic element 130 via the voids created in the side-margin-section ceramic green sheets 136 and 137. Thus, the low resin content ratio in the side-margin-section ceramic green sheets 136 and 137 can further facilitate the release of the decomposition gas from the chip laminate 120.

According to the foregoing manufacturing method, due to the high Si concentration in the first and second laminate ceramic green sheets 101 and 102 in the chip laminate 120, the ceramic material in the first and second laminate ceramic green sheets 101 and 102 can be fired at lower temperatures. This can prevent excessive sintering of the first and second internal electrode patterns 111 and 112 formed on the surfaces of the first and second laminate ceramic green sheets 101 and 102.

During firing, Si becomes a liquid-phase glass containing SiO₂, which flows within the ceramic element 130. In the vicinity of the boundaries between (i) the chip laminate 120 and (ii) the side-margin-section ceramic green sheets 136 and 137, the liquid-phase glass migrates from the chip laminate 120, which has a high Si concentration, to the side-margin-section ceramic green sheets 136 and 137. In the side-margin-section ceramic green sheets 136 and 137, particularly near their boundaries with the chip laminate 120, the densification is more likely to progress due to the liquid-phase glass supplied from the chip laminate 120. After firing, in each of the first and second side margin sections 16 and 17, a relatively smaller number of voids 30 are left in the region adjacent to the stacked section 15 (e.g., the inner portion 16a), and the voids 30 increase toward the outside of the laminated ceramic capacitor 1.

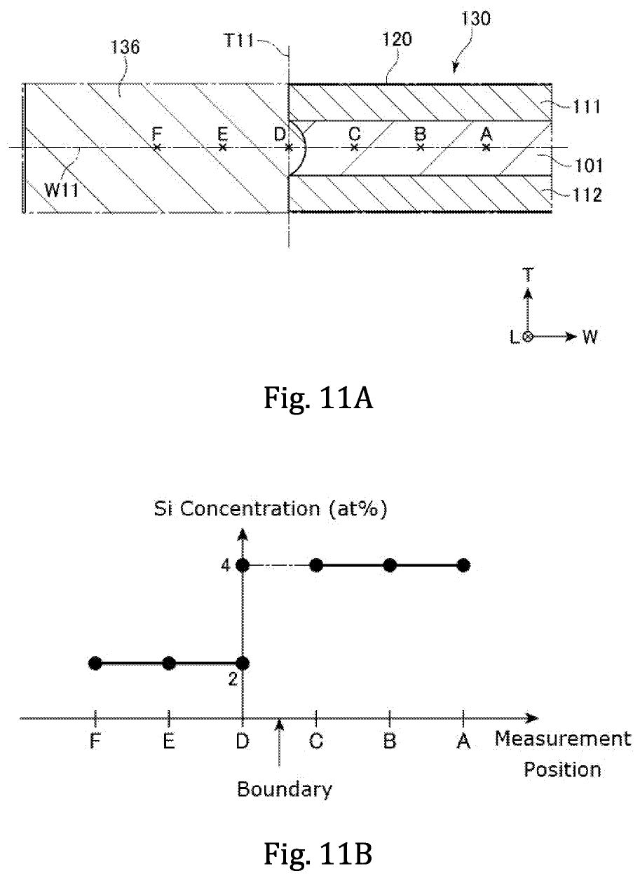

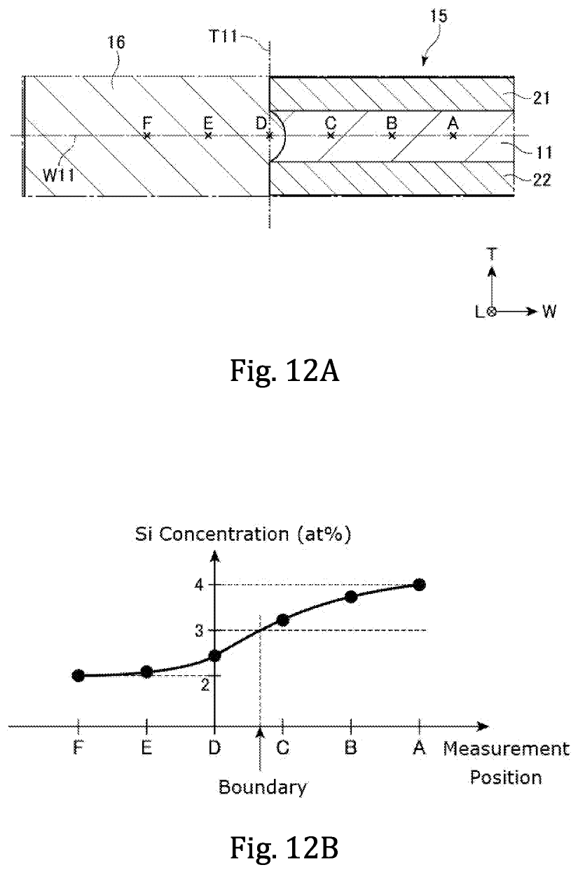

Before firing, the boundaries between (i) the chip laminate 120 and (ii) the side-margin section ceramic green sheets 136 and 137 are visible in SEM images. After firing, the boundaries between (i) the dielectric layers 11 in the stacked section 15 and (ii) the first and second side margin sections 16 and 17 may not be visible in SEM images. With reference to FIGS. 11A and 11B, the following now describes how to determine the boundary between (i) the chip laminate 120 and (ii) the side-margin-section ceramic green sheet 136 in the ceramic element 130 before firing. The following also describes, referring to FIGS. 12A and 12B, how to determine the boundaries between (i) the dielectric layers 11 in the stacked section 15 and (ii) the first side margin section 16 in the laminated ceramic capacitor 1 after sintering.

FIG. 11A is an enlarged sectional view of the boundary area between the chip laminate 120 and the side-margin-section ceramic green sheet 136 in the ceramic element 130 before firing. As mentioned above, when the side-margin-section ceramic green sheet 136 is attached to the first side surface 120e of the chip laminate 120, the side-margin-section ceramic green sheet 136 pushes the end surface of a first laminate ceramic green sheet 101 of the chip laminate 120 toward the inside of the chip laminate 120. Therefore, as shown in FIG. 11A, the side-margin-section ceramic green sheet 136 is embedded into the chip laminate 120 beyond the end surfaces of the first and second internal electrode patterns 111 and 112. The boundary between the chip laminate 120 and the side-margin-section ceramic green sheet 136 can be visually determined in SEM images. The location of this boundary can also be estimated by using the difference in Si concentration between the side-margin-section ceramic green sheet 136 and the first laminate ceramic green sheet 101. In the following explanation, it is assumed that 4 at % Si is added to the laminate ceramic slurry, from which the first laminate ceramic green sheet 101 is made, in relation to 100 at % of the main component oxide, and that 2 at % Si is added to the side-margin-section ceramic slurry, from which the side-margin-section ceramic green sheet 136 is made, in relation to 100 at % of the main component oxide.

First, six measurement points A to F are set at equal intervals on a virtual line W11 that passes through the middle of the first laminate ceramic green sheet 101 in the T-axis direction and extends along the W axis. The positions of the measurement points A to F on the virtual line W11 are determined as follows. First, the measurement point D is at the intersection of the virtual line W11 and a virtual line T11 that passes through the end surfaces of the first and second internal electrode patterns 111 and 112. The measurement points A to C are located in the order of the measurement point C, measurement point B, and measurement point A from the measurement point D toward the inside of the chip laminate 120 (toward the positive side of the W axis). The measurement points E and F are located in the order of the measurement point E and measurement point F starting from the measurement point D and moving away from the chip laminate 120 (toward the negative side of the W axis). The Si concentration is then measured at the respective measurement points A to F located in the above-described manner. The Si concentration can be measured, for example, by an electron probe microanalyzer. The measurement points A to F are placed at sufficient intervals to cross the boundary between the first laminate ceramic green sheet 101 and the side-margin-section ceramic green sheet 136. The distance between the measurement points C and D can be about half the thickness of the first laminate ceramic green sheet 101. For example, when the thickness of the first laminate ceramic green sheet 101 is 0.6 μm (600 nm), the distance between the measurement points C and D is 0.3 μm. This means that the interval between the adjacent measurement points is 0.3 μm, and the distance between the measurement points A and D is 0.9 μm. The interval between the adjacent measurement points can be determined in any other methods than the method described above. The interval between the adjacent measurement points shown in FIG. 11A is greater than half the thickness of the first laminate ceramic green sheet 101.

The Si concentration is then measured at the respective measurement points A to F. The results are shown in FIG. 11B. FIG. 11B shows an example of a graph showing the results of measuring the Si concentration at the six measurement points A to F. Since the side-margin-section ceramic green sheet 136 is embedded into the chip laminate 120 beyond the end surface of the first internal electrode pattern 111, the measurement point D, which is located at the same position as the end surface of the first internal electrode pattern 111 in the W-axis direction, and the measurement points E and F, which are located more distant from the chip laminate 120 than is the measurement point D, are located in the side-margin-section ceramic green sheet 136. Therefore, as shown in FIG. 11B, the measured value of the Si concentration at the measurement points D to F is 2 at %, the same as the Si content ratio in the side-margin-section ceramic slurry. On the other hand, the measurement points A to C are located in the first laminate ceramic green sheet 101. Therefore, the measured value of the Si concentration at the measurement points A to C is 4 at %, the same as the content ratio in the laminate ceramic slurry. Based on the difference between the Si concentration at the measurement points A to C and the Si concentration at the measurement points D to F, the boundary between the side-margin-section ceramic green sheet 136 and the first laminate ceramic green sheet 101 can be estimated to be between the measurement points C and D.

There is a possibility that the side-margin-section ceramic green sheet 136 may be further embedded into the chip laminate 120 than the position shown in FIG. 11A. In this case, the measured value of the Si concentration at the measurement point C could be 2 at %. In this case, it can be estimated that the boundary between the side-margin-section ceramic green sheet 136 and the first laminate ceramic green sheet 101 is between the measurement points B and C.

Thus, even if the boundary between the side-margin-section ceramic green sheet 136 and the first laminate ceramic green sheet 101 is not visually identifiable, the difference in Si concentration can be used to accurately estimate the position of the boundary between the side-margin-section ceramic green sheet 136 and the first laminate ceramic green sheet 101.

The body 10 is produced by firing the ceramic element 130 shown in FIG. 11A. FIG. 12A is an enlarged sectional view of the boundary area between the stacked section 15 and the first side margin section 16 in the body 10 obtained by firing the ceramic element 130 shown in FIG. 11A. The observed area in the body 10 shown in FIG. 12A corresponds to the observed area in the ceramic element 130 shown in FIG. 11A. In FIG. 12A, the boundary between the dielectric layer 11 and the first side margin section 16 is drawn in solid line, but this boundary may not be visible in the SEM image of the section of the body 10. When the boundary between the dielectric layer 11 and the first side margin section 16 is not visible, the location of the boundary can be estimated using the difference in Si concentration between the first side margin section 16 and the dielectric layer 11. The position of the boundary between the dielectric layer 11 and the first side margin section 16 can be estimated in the same way as the above-mentioned method of estimating the position of the boundary between the side-margin-section ceramic green sheet 136 and the first laminate ceramic green sheet 101 before firing.

Specifically, first, the Si concentration is measured at the respective measurement points A to F. The results are shown in FIG. 12B. During firing, the liquid-phase glass containing SiO₂ moves from the first laminate ceramic green sheet 101 to the side-margin-section ceramic green sheet 136. Therefore, the Si concentration at the measurement points D and E increases from 2 at %, which is measured before firing. The Si concentration at the measurement point F also increases, but the increase is slight because the measurement point F is distant from the first laminate ceramic green sheet 101. On the other hand, the Si concentration at the measurement points B and C decreases from 4 at %, which is observed before the measurement, due to the outflow of Si to the side-margin-section ceramic green sheet 136. The measurement point A is far away from the side-margin-section ceramic green sheet 136, and the decrease in Si concentration is thus slight.

Considering that the liquid-phase glass containing SiO₂ migrates from the first laminate ceramic green sheet 101 toward the side-margin-section ceramic green sheet 136 during firing, the Si concentration near the boundary between the dielectric layer 11 and the first side margin section 16 after firing is likely to be approximately equal to the average of the Si concentration in the side-margin-section ceramic green sheet 136 before firing and the Si concentration in the first laminate ceramic green sheet 101 before firing. In the above example, since the Si concentration in the side-margin-section ceramic green sheet 136 before firing is 2 at % and the Si concentration in the first laminate ceramic green sheet 101 before firing is 4 at %, the Si concentration near the boundary between the dielectric layer 11 and the first side margin section 16 is expected to be approximately 3 at %. In FIG. 12B, an Si concentration of 3 at % is measured at the position between the measurement points C and D. Therefore, based on the graph in FIG. 12B, the boundary between the dielectric layer 11 and the first side margin section 16 can be estimated to be between the measurement points C and D. When the boundary between the dielectric layer 11 and the first side margin section 16 is between the measurement points D and C, it can be confirmed that the first side margin section 16 has the protrusion 16a1 that protrudes into the chip laminate 120.

As described above, when the boundary between the dielectric layer 11 and the first side margin section 16 is not visible, the location of the boundary between the dielectric layer 11 and the first side margin section 16 can be estimated based on the distribution of Si concentration near the end surfaces of the first and second internal electrode layers 21 and 22 (specifically, near the intersection of the virtual lines T11 and W11). Specifically, a plurality of measurement points are set along a virtual line (e.g., the virtual line W11 shown in FIG. 12A) that extends along the W-axis direction across the dielectric layer 11 and the first side margin section 16. Based on the Si concentrations measured at these measurement points, an average concentration position is identified at which the measured Si concentration is approximately equal to the average of the Si concentration in the first laminate ceramic green sheet 101, which is the precursor of the dielectric layer 11, and the Si concentration in the side-margin-section ceramic green sheet 136, which is the precursor of the first side margin section 16. The average concentration position thus identified can be estimated as the location of the boundary between the dielectric layer 11 and the first side margin section 16. In the example shown in FIG. 12B, the average of the Si concentration in the first laminate ceramic green sheet 101 and the Si concentration in the side-margin-section ceramic green sheet 136 is 3 at %, and an Si concentration of 3 at % is found in the section between the measurement points C and D. Therefore, the position where the Si concentration of 3 at % is observed between the measurement points C and D can be estimated as the position of the boundary between the dielectric layer 11 and the first side margin section 16.

Return to the description of the manufacturing method. After the firing in the step S6 is completed, the first and second external electrodes 31 and 32 are formed on the body 10 obtained in the step S6. In this way, the laminated ceramic capacitor 1 is completed. The first and second external electrodes 31 and 32 can be formed by any known method.

In the above-described manner, the laminated ceramic capacitor 1 is manufactured.

Processes not shown in the flowchart of FIG. 5 may be performed to produce the laminated ceramic capacitor 1. For example, the laminated ceramic capacitor 1 obtained in the step S7 may be subjected to re-oxidation treatment at 600° C. to 1000° C. in an N₂ gas atmosphere.

### (3) Examples

The present disclosure will now be further described in detail based on examples. The present disclosure is not limited to the following examples.

### (3-1) Preparation of Samples

To evaluate the capacitance and reliability of the laminated ceramic capacitor 1, 12 different samples (Samples 1 to 12) were fabricated according to the manufacturing method described above.

### Manufacturing of Samples 1 to 12

First, a laminate ceramic slurry was prepared by wet mixing barium titanate powder with binder resin (PVB resin), Si oxide powder, silicon resin, solvent, and plasticizer. The amounts of the binder resin and silicon resin added in the laminate ceramic slurry were as listed in the “Binder Amount” and “Silicon Resin Amount” columns in the “Ceramic Slurry 1” section of Table 1, respectively. The amounts of the binder resin and silicon resin added are both expressed as additions to 100 wt % of the main component oxide. This laminate ceramic slurry was coated on a substrate film, and the laminate ceramic slurry coated on the substrate film was dried. In this way, a plurality of laminate ceramic green sheets were obtained. An internal electrode paste, in which Ni is dispersed in binder resin, was printed on each of the laminate ceramic green sheets. In this way, first laminate ceramic green sheets with first internal electrode patterns and second laminate ceramic green sheets with second internal electrode patterns were fabricated. Next, the first and second laminate ceramic green sheets were stacked alternately, thereby forming a mother laminate. The number of sheets in the mother laminate was 500. Next, the mother laminate was cut into chip laminates. Each chip laminate has first and second side surfaces where the end surfaces of the first and second internal electrode patterns are both exposed.

Next, a side-margin-section ceramic slurry was prepared by adding binder resin (PVB resin), solvent and plasticizer to barium titanate powder, adding Si at a ratio of 1 at % to 100 at % of the barium titanate powder, and performing wet mixing. The amount of the binder resin added in the side-margin-section ceramic slurry was as listed in the “Binder Amount” column in the “Ceramic Slurry 2” section of Table 1.

As mentioned above, Si oxide powder is added to the laminate ceramic slurry and the side-margin-section ceramic slurry. The Si oxide powder added to the laminate ceramic slurry was weighed such that the Si concentration in the stacked section of the body resulting from the firing process, which will be described below, would be the value listed in the “Post-Sintering Si Concentration” column in the “Ceramic Slurry 1” section in Table 1. The Si oxide powder added to the side-margin-section ceramic slurry was weighed such that the Si concentration in the side margin section of the body would be the value listed in the “Post-Sintering Si Concentration” column in the “Ceramic Slurry 2” section in Table 1. For Samples 1 to 9, the Si oxide powder to be added to the respective slurries was weighed such that the content ratio of the Si oxide powder in the side-margin-section ceramic slurry would be lower than that in the laminate ceramic slurry. For Samples 11 and 12, in contrast, the Si oxide powder to be added to the respective slurries was weighed such that the content ratio of the Si oxide powder in the side-margin-section ceramic slurry would be higher than that in the laminate ceramic slurry. For Sample 10, the Si oxide powder to be added to the respective slurries was weighed such that the content ratio of the Si oxide powder in the side-margin-section ceramic slurry would be equal to that in the laminate ceramic slurry. The Si concentrations listed in Table 1 are expressed as an atomic percentage of Si to 100 at % barium titanate powder. The post-sintering Si concentrations listed in Table 1 are target values, and the actual Si concentrations in the stacked sections and side margin sections of the actual laminated ceramic capacitors fabricated as Samples 1 to 12 had slight errors within +−5% from the target values listed in Table 1.

The side-margin-section ceramic green sheets prepared as described above were attached to the first and second side surfaces of the chip laminates, whereby ceramic elements were produced.

Next, the ceramic elements obtained as described above were fired according to the following firing conditions.
Atmosphere: Low oxygen atmosphere (oxygen partial pressure 10-10 MPa)
Temperature profile:
   Temperature increase rate from room temperature to intermediate temperature (600° C.): 300° C./h
   Temperature increase rate from intermediate temperature to top firing temperature (1150° C.): 1000° C./h
Holding time at top firing temperature: 20 minutes

As will be described below, for Samples 10 to 12, the sintering of the barium titanate in the dielectric layers was insufficient under the above heating conditions. For this reason, the holding time at the top firing temperature was set to 120 minutes for Samples 10 to 12.

After firing, the ceramic elements (the bodies) had the 1005 shape (length: 1.0 mm, width: 0.5 mm, height: 0.5 mm). The bodies have a stacked section resulting from firing the pre-firing chip laminate, and side margin sections resulting from firing the pre-firing side-margin-section ceramic green sheets. The first and second external electrodes were then attached to the bodies, whereby the laminated ceramic capacitors of Sample 1 were fabricated.

The Si concentration in the stacked section (first concentration) and the Si concentration in the side margin sections (second concentration) of each Sample were measured by thinning the body and side margin sections of each Sample such that the surface parallel to the plane including the T-axis (LT plane) became an observation surface and performing TEM-EDX on the thin pieces obtained from the body and side margin sections, respectively. The first concentrations measured in this way deviated within 5 at % from the target values listed in the “Post-Sintering Si concentration” column of the “Ceramic Slurry 1” Section in Table 1, and the second concentrations measured deviated within 5 at % from the target values listed in the “Post-Sintering Si concentration” column of the “Ceramic Slurry 2” Section in Table 1.

### (3-2) Evaluation of Capacitance

Capacitance was measured for each of Samples 1 to 12. The capacitance was measured using an LCR meter with an AC applied voltage of 1 Vrms at 1 KHz. One hundred pieces were selected for each of Samples 1 to 12, the capacitance was determined for each of these 100 pieces, and the average of the measured values were taken as the capacitance of each Sample. The pieces with a difference of 0 to 5% between the measured value of the capacitance (average value) and the design value of the capacitance were judged as pass, and the pieces with a difference of greater than 5% were judged as fail. The ratio of the measured value of the capacitance of each Sample to the design value, expressed as a percentage, is listed in the “Capacitance” column of Table 1. The results of the pass/fail decisions are also listed in the “Capacitance Evaluation” column of Table 1.

### (3-3) Evaluation of Reliability

One hundred pieces were selected for each of Samples 1 to 12, and a reliability test was performed on each of these selected pieces. The reliability test was performed as follows: the selected pieces were subjected to a DC voltage of 100 V at a temperature of 85° C. and with a humidity of 85% for 1000 hours. The insulation resistance of each piece was subsequently measured. Samples with less than five pieces exhibiting an insulation resistance of less than 1 MΩ were judged as passing, and those with five or more pieces exhibiting an insulation resistance of less than 1 MΩ were judged as failing. For each Sample, the number of pieces with an insulation resistance of less than 1 MΩ out of 100 pieces is listed in the “Non-Conforming Piece Number” column in Table 1. The results of the pass/fail decisions are listed in the “Reliability” column of Table 1 for each Sample.

### (3-4) Evaluation of Adhesion

During the manufacture of Samples 1 to 12, the appearance of 100 ceramic bodies per Sample, which were formed by attaching the side-margin-section ceramic green sheets to the chip laminates, was inspected to confirm whether peeling of the side-margin-section ceramic green sheets from the chip laminates had occurred. It was confirmed that the side-margin-section ceramic green sheets had not peeled off from the chip laminates in any of Samples 1 to 12.

TABLE 1

| | Ceramic Slurry 1 | | | Ceramic Slurry 2 | | | Eval- | | |
|---|---|---|---|---|---|---|---|---|---|
| | | Silicon | Post- | | Post- | | uation | | |
| | Binder | Resin | Sintering Si | Binder | Sintering Si | | of | Failing | |
| Sample | Amount | Amount | Concentration | Amount | Concentration | Capaci- | Capaci- | Piece | Reli- |
| Number | (wt %) | (wt %) | (at %) | (wt %) | (at %) | tance | tance | Count | ability |
| Sample 1 | 10 | 2 | 3 | 7 | 1 | 100 | Pass | 0/100 | Pass |
| Sample 2 | 10 | 2 | 4 | 7 | 1 | 99 | Pass | 0/100 | Pass |
| Sample 3 | 10 | 2 | 5 | 7 | 2 | 96 | Pass | 1/100 | Pass |
| Sample 4 | 10 | 2 | 5 | 7 | 1 | 96 | Pass | 2/100 | Pass |
| Sample 5 | 10 | 2 | 5 | 7 | 0.5 | 96 | Pass | 3/100 | Pass |
| Sample 6 | 9 | 4 | 3 | 5 | 1 | 98 | Pass | 0/100 | Pass |
| Sample 7 | 10 | 2 | 4 | 7 | 2 | 96 | Pass | 2/100 | Pass |
| Sample 8 | 9 | 4 | 4 | 5 | 2 | 95 | Pass | 2/100 | Pass |
| Sample 9 | 10 | 2 | 6 | 7 | 1 | 95 | Pass | 3/100 | Pass |
| Sample 10 | 10 | 2 | 1 | 7 | 1 | 82 | Fail | 6/100 | Fail |
| Sample 11 | 10 | 2 | 3 | 7 | 3.5 | 94 | Fail | 6/100 | Fail |
| Sample 12 | 10 | 2 | 6 | 7 | 0.5 | 92 | Fai | 6/100 | Fai |

### (3-5) Analysis

The above experimental results show that Samples 1 to 9, where the Si concentration in the laminate ceramic slurry is higher than that in the side-margin-section ceramic green sheets, achieve excellent capacitance and reliability. The reason why Samples 1 to 9 achieve excellent capacitance is thought to be because the Si concentration in the laminate ceramic slurry was higher than that in the side-margin-section ceramic green sheets for Samples 1 to 9. For this reason, the ceramic material in the laminate ceramic slurry started sintering at an earlier time, which facilitated the release of the decomposition gas generated during firing. This therefore eliminates the need for an extended firing time to release the decomposition gas. If the firing time is extended to release the decomposition gas, the internal electrode layers become oversintered, resulting in a decrease in capacitance. However, in Samples 1 to 9, since no additional firing time is required to release the decomposition gas, it is thought that the excessive progress of the sintering was suppressed in the internal electrode layers. Similarly, in Samples 1 to 9, since no additional firing time is required to release the decomposition gas, excessive growth of the ceramic crystal grains can be suppressed. It is believed that good results were obtained in the reliability test because the excessive growth of the ceramic crystal grains can be suppressed, preventing cracks in the stacked section 15 and the side margin sections.

Comparing the experimental results for Samples 1 to 9 indicates that the samples where the first concentration is 2.5 to 4 times higher than the second concentration (Samples 1 to 3 and 6) are particularly excellent from the perspectives of capacitance and reliability since their capacitance is more than 96% of the design value and their non-conforming piece number is less than 1. For the samples where the first concentration is about twice as high as the second concentration (Samples 7 and 8), they exhibit a slightly lower capacitance and a slightly higher non-conforming piece number than Samples 1 to 3 and 6. For the samples where the first concentration is 5 to 10 times higher than the second concentration (Samples 4, 5, and 9), they exhibit a slightly lower capacitance and a slightly higher non-conforming piece number than Samples 1 to 3 and 6. The above results have confirmed that sufficient capacitance and reliability can be reliably achieved when the first concentration is in the range of 2 to 10 times the second concentration, and that particularly excellent capacitance and reliability can be accomplished when the first concentration is 2.5 to 4 times the second concentration.

As for Sample 10, the Si concentration was as low as about 1 at % in both the stacked section and the side margin sections, and the holding time at the top firing temperature was thus as long as 120 minutes. The longer holding time at the top firing temperature is considered to have caused excessive sintering of the metal particles in the internal electrode layers and the ceramic crystal grains in the dielectric layers in Sample 10, resulting in lower capacitance and reliability.

For Sample 11, the Si concentration in the laminate ceramic slurry was lower than the Si concentration in the side-margin-section ceramic green sheets. Therefore, before the start of the sintering of the ceramic material in the laminate ceramic slurry, the ceramic material in the side-margin-section ceramic green sheets started to sinter and had been densified. Therefore, by the time the release of the decomposition gas started due to the start of the sintering of the ceramic material in the laminate ceramic slurry, the densification of the ceramic grains in the side-margin-section ceramic green sheets had already progressed, narrowing the paths through which the decomposition gas could be released. This is considered to have inhibited the release of the decomposition gas. To release the decomposition gas, the holding time at the top firing temperature during the fabrication was set longer for Sample 11 than for Samples 1 to 9. Therefore, Sample 11 is thought to have experienced excessive sintering of the internal electrode layers and ceramic grains, which compromised the capacitance and reliability.

In Sample 12, the Si concentration in the laminate ceramic slurry was 12 times higher than that in the side-margin-section ceramic green sheets, so the sintering of the ceramic material in the side-margin-section ceramic green sheets is thought to have started significantly later than the sintering of the ceramic material in the laminate ceramic slurry. Therefore, when the release of the decomposition gas occurs due to the start of the sintering of the ceramic material in the laminate ceramic slurry, the sintering of the side-margin-section ceramic green sheets has not started. The paths for the release of the decomposition gas thus have not been formed. This is considered to have inhibited the release of the decomposition gas. To release the decomposition gas, the holding time at the top firing temperature during the fabrication was set longer for Sample 12 than for Samples 1 to 9. Therefore, Sample 12 is thought to have experienced excessive sintering of the internal electrode layers and ceramic grains, which compromised the capacitance and reliability.

The above has confirmed the following. By setting the Si concentration in the laminate ceramic slurry higher than that in the side-margin-section ceramic green sheets, the release of the decomposition gas can start at an early stage after the start of firing. This eliminates the need for a longer firing time and can thus contribute to completing the sintering without compromising the capacitance and reliability.

In all of Samples 1 to 9, even though the percentage of the binder resin contained in the side-margin-section ceramic green sheets was less than the percentage of the binder resin in the laminate ceramic slurry, the adhesion of the side-margin-section ceramic green sheets to the chip laminates was sufficient. In Samples 1 to 9, the laminate ceramic slurry contains 2 wt % or more silicon resin. This silicon resin improves the flexibility of the laminate ceramic slurry. The high flexibility of the laminate ceramic slurry is thought to have enabled the side-margin-section ceramic green sheets to be embedded into the laminate ceramic slurry in the chip laminate when the side-margin-section ceramic green sheets are attached to the chip laminate, thereby ensuring the sufficient adhesion of the side-margin-section ceramic green sheets to the chip laminate.

### (3-6) Other Tests

Attempts were made to manufacture laminated ceramic capacitors under the same conditions as Sample 1 except for that, compared to Sample 1, the percentage of the silicon resin added to the raw material for the laminate ceramic slurry was reduced from 2 wt % to 0.5 wt %. However, the manufacturing was terminated since the side-margin-section ceramic green sheets were attached to the chip laminates but subsequently peeled off. This experiment has demonstrated that sufficient adhesion between the side-margin-section ceramic green sheets and the chip laminates could not be ensured with the content ratio of silicon resin being 0.5 wt % or less in the raw material for the laminate ceramic slurry when only a small amount of binder resin was contained in the side-margin-section ceramic green sheets and the side-margin-section ceramic green sheets thus have low flowability. As described above, in Samples 1 to 9 where the content ratio of silicon resin added to the raw material of the laminate ceramic slurry was 2 wt % or more, it is thought that, when the side-margin-section ceramic green sheets were attached to the chip laminates, the side-margin-section ceramic green sheets were embedded into the laminate ceramic slurry in the chip laminates to ensure high adhesion. However, when the content ratio of silicon resin added to the raw material of the laminate ceramic slurry was 0.5 wt % or lower, the side-margin-section ceramic green sheets were not embedded into the laminate ceramic slurry in the chip laminates due to the insufficient flexibility (i.e., high rigidity) of the laminate ceramic slurry. Therefore, the percentage of silicon resin added to the raw material of the laminate ceramic slurry is preferably 2 wt % or more to ensure sufficient flexibility of the laminate ceramic slurry to such an extent that the side-margin-section ceramic green sheets can be embedded into the laminate ceramic slurry.

Attempts were made to manufacture laminated ceramic capacitors under the same conditions as Sample 1 except for that no silicon resin was added to the raw material of the laminate ceramic slurry and that the percentage of the binder resin added to the raw material of the side-margin-section ceramic green sheets was increased from 7 wt % to 10 wt %. However, the manufacturing was terminated since the side-margin-section ceramic green sheets were attached to the chip laminates but subsequently peeled off. This experiment has demonstrated that, if the percentage of the binder resin added to the raw material of the laminate ceramic slurry was equal to the percentage of the binder resin added to the raw material of the side-margin-section ceramic green sheets, that is to say, if the flowability is equal between the laminate ceramic green sheets and the side-margin-section ceramic green sheets, sufficient adhesion between the side-margin-section ceramic green sheets and the chip laminates could not be ensured without the silicon resin in the raw material of the laminate ceramic slurry. This is thought to be because the side-margin-section ceramic green sheets cannot be embedded into the laminate ceramic slurry in the chip laminates when the side-margin-section ceramic green sheets are attached to the chip laminates. Therefore, it is desirable that the percentage of the binder resin added to the raw material of the laminate ceramic slurry be greater than the percentage of the binder resin added to the raw material of the side-margin-section ceramic green sheets.

To improve the adhesion between the side-margin-section ceramic green sheets and the chip laminates, the binder resin contained in the raw material of the laminate ceramic slurry may have a lower glass transition temperature than the binder resin contained in the raw material of the side-margin-section ceramic green sheets. An adhesion promoter may also be added to at least one of the raw material of the laminate ceramic slurry or the raw material of the side-margin-section ceramic green sheets. By adding a binder resin with a lower glass transition temperature to the raw material of the laminate ceramic slurry than the binder resin contained in the raw material of the side-margin-section ceramic green sheets, or by adding an adhesion promoter to at least one of the raw material of the laminate ceramic slurry or the raw material of the side-margin-section ceramic green sheets, the side-margin-section ceramic green sheets can be tightly attached to the chip laminates even with less than 2 wt % of silicon resin being added to the raw material of the laminate ceramic slurry.

### (4) Notes

The dimensions, materials, and arrangements of the constituent elements described for the above various embodiments are not limited to those explicitly described for the embodiments, and these constituent elements can be modified to have any dimensions, materials, and arrangements within the scope of the present disclosure.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) Additional Embodiments

Embodiments disclosed herein also include the following.

### Additional Embodiment 1

A laminated ceramic capacitor comprising:
a body (10) including a stacked section (15) and a side margin section (16, 17), the stacked section (15) having a first internal electrode layer (21), a second internal electrode layer (22), and a dielectric layer (11) arranged between the first and second internal electrode layers in a first direction (T), the dielectric layer containing Si, the side margin section being made from an Si-added ceramic material;
a first external electrode (31) provided on the body so as to be electrically connected to the first internal electrode layer; and
a second external electrode (32) provided on the body so as to be electrically connected to the second internal electrode layer,
wherein a first concentration indicating an Si concentration in the dielectric layer in the stacked section is higher than a second concentration indicating an Si concentration in the side margin section.

### Additional Embodiment 2

The laminated ceramic capacitor of Additional Embodiment 1, wherein when viewed from the first direction, neither the first internal electrode layer nor the second internal electrode layer is present in the side margin section.

### Additional Embodiment 3

The laminated ceramic capacitor of Additional Embodiment 1 or 2, wherein the dielectric layer has a plurality of ceramic crystal grains constituting a sintered body of a ceramic material.

### Additional Embodiment 4

The laminated ceramic capacitor of any one of Additional Embodiments 1 to 3, wherein the side margin section has a first side margin section (16) and a second side margin section (17) sandwiching the stacked section in a second direction (W).

### Additional Embodiment 5

The laminated ceramic capacitor of Additional Embodiment 4, wherein the dielectric layer has a recess (11a) that is recessed from one end (21a) of the first internal electrode layer in the second direction toward an inside of the stacked section.

### Additional Embodiment 6

The laminated ceramic capacitor of Additional Embodiment 5, wherein the first side margin section has a protrusion (16a1) protruding beyond the one end of the first internal electrode layer in the second direction toward the inside of the stacked section.

### Additional Embodiment 7

The laminated ceramic capacitor of any one of Additional Embodiments 4 to 6, wherein, when the first side margin section is divided into three equal portions that are next to each other in the second direction, the first side margin section has:
an inner portion (16a) in contact with the stacked section;
a middle portion (16b) in contact with the inner portion; and
an outer portion (16c) that is opposite the inner portion with respect to the middle portion in the second direction, and
wherein, in a section of the body taken along the first and second directions, a first area indicating an area of a void (30) in the inner portion is less than a second area indicating an area of a void in the middle portion.

### Additional Embodiment 8

The laminated ceramic capacitor of Additional Embodiment 7, wherein the first area is less than 0.5% of an inner portion area indicating an area of the inner portion in the section.

### Additional Embodiment 9

The laminated ceramic capacitor of Additional Embodiment 7 or 8, wherein in a section of the body taken along the first and second directions, the second area is less than a third area indicating an area of a void in the outer portion.

### Additional Embodiment 10

The laminated ceramic capacitor of any one of Additional Embodiments 1 to 9, wherein the ceramic crystal grains are mainly composed of barium titanate.

### Additional Embodiment 11

The laminated ceramic capacitor of any one of Additional Embodiments 1 to 10, wherein the first concentration is no less than two times the second concentration.

### Additional Embodiment 12

The laminated ceramic capacitor of Additional Embodiment 11, wherein the first concentration is no more than ten times the second concentration.

### Additional Embodiment 13

A circuit module comprising the laminated ceramic capacitor of any one of Additional Embodiments 1 to 11.

### Additional Embodiment 14

An electronic device comprising the circuit module of Additional Embodiment 13.

### Additional Embodiment 15

A method of manufacturing a laminated ceramic capacitor, the method including steps of:
preparing a plurality of laminate ceramic green sheets containing Si (S1);
forming a first internal electrode pattern on a surface of each of a plurality of first laminate ceramic green sheets (101) from among the plurality of laminate ceramic green sheets (S2);
forming a second internal electrode pattern on a surface of each of a plurality of second laminate ceramic green sheets from among the plurality of laminate ceramic green sheets (S2);
alternately stacking the plurality of first laminate ceramic green sheets and the plurality of second laminate ceramic green sheets in a first direction to form a mother laminate where a plurality of first internal electrode patterns face a plurality of second internal electrode patterns in the first direction (S3);
cutting the mother laminate along a first cutting line (Ll) extending in a second direction orthogonal to the first direction and a second cutting line (Lw) extending in a third direction orthogonal to the first and second directions, so that a chip laminate (120) is produced, the chip laminate having a cut surface (120e, 120f) that is exposed by the cutting along the first cutting line and where end surfaces of the plurality of first internal electrode patterns and end surfaces of the plurality of second internal electrode patterns are exposed;
providing a side-margin ceramic green sheet on the cut surface of the chip laminate such that the side-margin ceramic green sheet covers the end surfaces of the plurality of first internal electrode patterns and the end surfaces of the plurality of second internal electrode patterns, the side-margin ceramic green sheet containing Si at a lower concentration than the laminate ceramic green sheet; and
firing the chip laminate having the side-margin ceramic green sheet provided thereon.

### Additional Embodiment 16

The method of Additional Embodiment 15, wherein a content ratio of resin in the side-margin ceramic green sheet is lower than a content ratio of resin in each of the plurality of laminate ceramic green sheets.

### Additional Embodiment 17

The method of Additional Embodiment 15 or 16, wherein each of the plurality of laminate ceramic sheets contains silicon resin.

### Additional Embodiment 18

The method of Additional Embodiment 17, wherein the side-margin ceramic green sheet contains no silicon resin.

What is claimed is:

1. A laminated ceramic capacitor comprising:
a body including a stacked section and a side margin section, the stacked section having a first internal electrode layer, a second internal electrode layer, and a dielectric layer arranged between the first and second internal electrode layers in a first direction, the dielectric layer containing Si, the side-margin section being in contact with the stacked section in a second direction orthogonal to the first direction, the side margin section being made from an Si-added ceramic material;
a first external electrode provided on the body so as to be electrically connected to the first internal electrode layer; and
a second external electrode provided on the body so as to be electrically connected to the second internal electrode layer,
wherein a first concentration indicating an Si concentration in the dielectric layer in the stacked section is higher than a second concentration indicating an Si concentration in the side margin section.

2. The laminated ceramic capacitor of claim 1, wherein when viewed from the first direction, neither the first internal electrode layer nor the second internal electrode layer is present in the side margin section.

3. The laminated ceramic capacitor of claim 1, wherein the dielectric layer has a plurality of ceramic crystal grains constituting a sintered body of a ceramic material.

4. The laminated ceramic capacitor of claim 1, wherein the side margin section has a first side margin section and a second side margin section sandwiching the stacked section in the second direction.

5. The laminated ceramic capacitor of claim 4, wherein the dielectric layer has a recess that is recessed from one end of the first internal electrode layer in the second direction toward an inside of the stacked section.

6. The laminated ceramic capacitor of claim 5, wherein the first side margin section has a protrusion protruding beyond the one end of the first internal electrode layer in the second direction toward the inside of the stacked section.

7. The laminated ceramic capacitor of claim 4,
wherein, when the first side margin section is divided into three equal portions that are next to each other in the second direction, the first side margin section has:
an inner portion in contact with the stacked section;
a middle portion in contact with the inner portion; and
an outer portion that is opposite the inner portion with respect to the middle portion in the second direction, and
wherein, in a section of the body taken along the first and second directions, a first area indicating an area of a void in the inner portion is less than a second area indicating an area of a void in the middle portion.

8. The laminated ceramic capacitor of claim 7, wherein the first area is less than 0.5% of an inner portion area indicating an area of the inner portion in the section.

9. The laminated ceramic capacitor of claim 7, wherein in a section of the body taken along the first and second directions, the second area is less than a third area indicating an area of a void in the outer portion.

10. The laminated ceramic capacitor of claim 3, wherein the ceramic crystal grains are mainly composed of barium titanate.

11. The laminated ceramic capacitor of claim 1, wherein the first concentration is no less than two times the second concentration.

12. The laminated ceramic capacitor of claim 11, wherein the first concentration is no more than ten times the second concentration.

13. A circuit module comprising the laminated ceramic capacitor of claim 1.

14. An electronic device comprising the circuit module of claim 13.

15. A method of manufacturing a laminated ceramic capacitor, the method including steps of:
preparing a plurality of laminate ceramic green sheets containing Si;
forming a first internal electrode pattern on a surface of each of a plurality of first laminate ceramic green sheets from among the plurality of laminate ceramic green sheets;
forming a second internal electrode pattern on a surface of each of a plurality of second laminate ceramic green sheets from among the plurality of laminate ceramic green sheets;
alternately stacking the plurality of first laminate ceramic green sheets and the plurality of second laminate ceramic green sheets in a first direction to form a mother laminate where a plurality of first internal electrode patterns face a plurality of second internal electrode patterns in the first direction;
cutting the mother laminate along a first cutting line extending in a second direction orthogonal to the first direction and a second cutting line extending in a third direction orthogonal to the first and second directions, so that a chip laminate is produced, the chip laminate having a cut surface that is exposed by the cutting along the first cutting line and where end surfaces of the plurality of first internal electrode patterns and end surfaces of the plurality of second internal electrode patterns are exposed;
providing a side-margin ceramic green sheet on the cut surface of the chip laminate such that the side-margin ceramic green sheet covers the end surfaces of the plurality of first internal electrode patterns and the end surfaces of the plurality of second internal electrode patterns, the side-margin ceramic green sheet containing Si at a lower concentration than the plurality of laminate ceramic green sheet; and
firing the chip laminate having the side-margin ceramic green sheet provided thereon.

16. The method of claim 15, wherein a content ratio of resin in the side-margin ceramic green sheet is lower than a content ratio of resin in each of the plurality of laminate ceramic green sheets.

17. The method of claim 15, wherein each of the plurality of laminate ceramic sheets contains silicon resin.

18. The method of claim 17, wherein the side-margin ceramic green sheet contains no silicon resin.
